(19) United States
(12) Patent Application Publication
(10) Pub. No.: US 2021/0350522 A1
(43) Pub. Date: Nov. 11, 2021

(54) INFORMATION PROCESSING APPARATUS, CONTROL METHOD, AND PROGRAM

(71) Applicant: NEC Corporation, Minato-ku, Tokyo (JP)

(72) Inventor: Asuka ISHII, Tokyo (JP)

(73) Assignee: NEC Corporation, Minato-ku, Tokyo (JP)

(21) Appl. No.: 17/278,361

(22) PCT Filed: Sep. 28, 2018
(86) PCT No.: PCT/JP2018/036443

§ 371 Date: Mar. 22, 2021

(51) Int. Cl. G06T 7/00; G06T 7/246

(52) U.S. Cl. CPC G06T 7/0004; G06T 7/246

(57) ABSTRACT

An information processing apparatus (2000) acquires observation information including a result of observing a structure (10) to which a moving load is applied, and determines, by using the observation information and a soundness condition, whether a relation between a temporal change in deflection amount of the structure (10) and a temporal change in an application position satisfies the soundness condition. The soundness condition is a condition, for deflection caused in the structure (10) by applying a load to the structure (10) while changing the application position, being satisfied when the structure (10) is sound. Then, the information processing apparatus (2000) outputs, based on a result of the determination, information relating to a degree of soundness of the structure (10).

### TECHNICAL FIELD

The present invention relates to inspection of a structure.

### BACKGROUND ART

A structure made of concrete or a steel material is used in various applications. For example, such structures include an infrastructure such as a tunnel or a bridge, a shell plate for an aircraft or an automobile, and the like. Such a structure is known to have a degree of soundness (a degree of normality) that is decreased by a defect such as a crack or a cavity caused on the surface or inside the structure. The decrease in a soundness degree of a structure can be a cause of an accident or the like, and thus, it is necessary to be able to recognize the soundness degree of the structure.

As a method of recognizing a soundness degree of a structure, there are a visual inspection and a hammering test performed by an inspector. However, such a method has problems including a high cost for preparing equipment with which an inspector approaches a structure, and a high cost for training a skillful inspector who is able to determine a soundness degree from a visual inspection or a hammering test. Thus, a method capable of more simply recognizing a soundness degree of a structure is desired.

As a method of determining a soundness degree of a structure, there is a method focusing on deflection by load application. PTL 1 discloses a method of determining a soundness degree by comparing deflection of a concrete floorboard to be measured with deflection of another concrete floorboard for reference in an ultimate state. PTL 2 discloses a method of mapping a defective part by calculating displacement amount of a structure in an in-plane direction from image measurement. PTL 3 discloses a method of detecting an abnormality by capturing, using an image capturing apparatus, an image of a bridge and measuring a deflection amount distribution of the bridge from the acquired image. The deflection amount distribution described herein is a distribution representing deflection amount of each position on the bridge. PTL 4 discloses a method of measuring a fatigue degree by using surface strain of a concrete structure.

### CITATION LIST

### Patent Literature

[PTL 1] Japanese Patent Application Publication No. 2002-90256

[PTL 2] International Publication No. WO 2016/152075

[PTL 3] Japanese Patent Application Publication No. 2016-84579

[PTL 4] Japanese Patent Application Publication No. 2014-109536

### SUMMARY OF INVENTION

### Technical Problem

The present inventor has found a new technique for recognizing a soundness degree of a structure by focusing on a property in structural mechanics of the structure. One objective of the present invention is to provide a new technique for recognizing a soundness degree of a structure.

### Solution to Problem

An information processing apparatus according to the present invention includes: 1) an acquisition unit that acquires observation information relating to a result of observing deflection of a structure caused by applying a load to the structure while changing an application position; 2) a determination unit that determines, by using the observation information, whether a temporal change in amount of the deflection and a temporal change in the application position satisfy a predetermined condition; and 3) an output unit that outputs, based on a determination result made by the determination unit, information relating to a degree of soundness of the structure.

A control method according to the present invention is executed by a computer. The control method includes: 1) an acquisition step of acquiring observation information relating to a result of observing deflection of a structure caused by applying a load to the structure while changing an application position; 2) a determination step of determining, by using the observation information, whether a temporal change in amount of the deflection and a temporal change in the application position satisfy a predetermined condition; and 3) an output step of outputting, based on a determination result made in the determination step, information relating to a degree of soundness of the structure.

A program according to the present invention causes a computer to execute each of steps included in the control method according to the present invention.

### Advantageous Effects of Invention

The present invention provides a new technique for recognizing a soundness degree of a structure.

### BRIEF DESCRIPTION OF DRAWINGS

The above-described objective and other objectives, features and advantages are more apparent from the following preferred example embodiments and the accompanying drawings.

FIG. 1 is a diagram illustrating a summary of an information processing apparatus according to an example embodiment 1.

FIG. 2 is a diagram illustrating a function configuration of the information processing apparatus according to the example embodiment 1.

FIG. 3 is a diagram illustrating a computer for achieving the information processing apparatus.

FIG. 4 is a flowchart illustrating a flow of processing executed by the information processing apparatus according to the example embodiment 1.

FIG. 5 is a flowchart illustrating a flow of processing of determining a soundness condition to be used.

FIG. 6 is a diagram illustrating information relating to determination of a soundness condition by means of a graph.

### EXAMPLE EMBODIMENT

Hereinafter, an example embodiment of the present invention will be described by using the drawings. Note that, similar components are assigned similar reference signs throughout all the drawings, and description therefor will be omitted as appropriate. Further, in each block diagram, each block represents not a configuration on a hardware basis but a configuration on a function basis, except as particularly described.

### Example Embodiment 1

### Summary of Invention

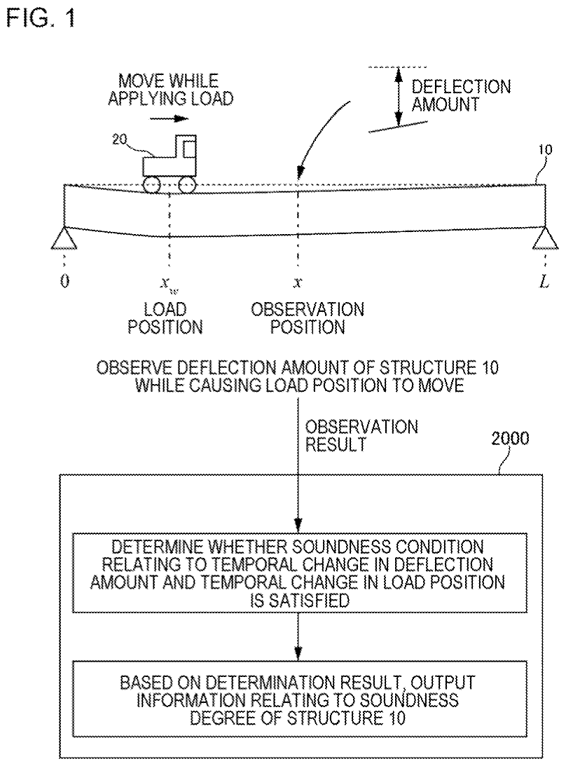

FIG. 1 is a diagram illustrating a summary of an information processing apparatus 2000 according to an example embodiment 1. The information processing apparatus 2000 according to the present example embodiment is an apparatus that can be used for recognizing a degree of soundness of a structure 10. The structure 10 is an object that is installed hanging in a substantially horizontal direction like a beam and supports a load applied from above. For example, in FIG. 1, the structure 10 is a bridge. The structure 10 is supported at least at two locations separated from each other.

In order to acquire observation data for recognizing a soundness degree of the structure 10, a load is applied to the structure 10 while an application position is changed. For example, in FIG. 1, an automobile 20 is used as a means for applying a load. Specifically, by causing the automobile 20 to move over the structure 10, weight of the automobile is applied to the structure 10 while the application position is changed.

The information processing apparatus 2000 determines whether a soundness condition is satisfied, regarding deflection caused in the structure 10 by applying a load to the structure 10 while changing the application position in such way. The soundness condition is a condition being satisfied when the structure 10 is sound, regarding the deflection caused in the structure 10 by applying a load to the structure 10 while changing the application position. Note that, in the following description, applying a load while changing the application position will be written also as “applying a moving load”.

The soundness condition to be used by the information processing apparatus 2000 is derived from an elastic curve equation. According to the elastic curve equation, when a concentrated load is given to a both-ends supported beam, deflection amount of the beam is given by the following equation (1).

$$\begin{matrix}[ Mathematical 1 ] & \\ δ = \{ \begin{matrix}\frac{f ( L - {x}_{w} )}{6 EIL} x ( - {x}^{2} - {x}_{w}^{2} + 2 {Lx}_{w} ) & ( 0 \leq x \leq {x}_{w} ) \\ \frac{f ( L - x )}{6 EIL} {x}_{w} ( - {x}_{w}^{2} - {x}^{2} + 2 Lx ) & ( {x}_{w} \leq x \leq L )\end{matrix} & ( 1 )\end{matrix}$$

Herein, x represents a position on the beam where deflection is observed, and δ represents the deflection amount of the beam. Further, L, E, and I represent a span length, a Young's modulus, and a second moment of area of the beam, respectively. xw represents the application position, and f represents magnitude of a load applied to the beam. Note that, an origin is one of two supports of the beam (in FIG. 1, a left support).

A derivation method will be described later. However, for example, as the soundness condition, a following equation (2) can be derived from the elastic curve equation in equation (1).

$$\begin{matrix}[ Mathematical 2 ] & \\ \frac{dδ}{dt} = \{ \begin{matrix}\frac{fx}{6 EIL} \{ 3 {( L - {x}_{w} )}^{2} + {x}^{2} - {L}^{2} \} \frac{\partial {x}_{w}}{\partial t} & ( 0 \leq x \leq {x}_{w} ) \\ \frac{f ( L - x )}{6 EIL} \{ - {( L - x )}^{2} - 3 {x}_{w}^{2} + {L}^{2} \} \frac{\partial {x}_{w}}{\partial t} & ( {x}_{w} \leq x \leq L )\end{matrix} & ( 2 )\end{matrix}$$

Herein, t represents a time.

When the structure 10 is sound, values on a left-hand side and a right-hand side in equation (2) are sufficiently close values (for example, a difference between the values is equal to or less than a threshold value) regarding the structure 10. Conversely, when the structure 10 is not sound, values on the left-hand side and the right-hand side in equation (2) are not close values (for example, a difference between the values is more than a threshold value) regarding the structure 10. Thus, with use of equation (2) as a determination criterion, the degree of soundness of the structure 10 can be recognized.

Herein, the left-hand side in equation (2) represents a temporal change in the deflection amount. Further, ∂xw/∂t in the right-hand side in equation (2) represents a temporal change in the application position (for example, a speed of the automobile 20). Therefore, the determination criterion in equation (2) can be regarded as a relational equation between the temporal change in the deflection amount and the temporal change in the application position.

In view of the above, the information processing apparatus 2000 acquires observation information including a result of observation performed on the structure 10 to which a moving load is applied, and determines, by using the observation information and the soundness condition, whether a relation between the temporal change in the deflection amount of the structure 10 and the temporal change in the application position satisfies the soundness condition. “Satisfying the soundness condition” described herein means that, for example, the difference between the left-hand side and the right-hand side in above-described equation (2) is equal to or less than a threshold value. Then, the information processing apparatus 2000 outputs, based on a result of the determination, information (hereinafter, output information) relating to the degree of soundness of the structure 10. For example, the output information indicates information indicating whether the structure 10 is sound, and an index representing how much the structure 10 is sound.

The observation information acquired by the information processing apparatus 2000 indicates the temporal change in the deflection amount and the temporal change in the application position regarding one or more times, or indicates an observation result that can be used for computation thereof. The temporal change in the deflection amount can be computed by, for example, acquiring a plurality of sets of “the deflection amount and the time at which the deflection amount is observed”. Similarly, the temporal change in the application position can be computed by, for example, acquiring a plurality of sets of “the application position and the time at which a load is applied to the application position”.

Note that, an equation usable as the soundness condition is not limited to the above-described equation (2). As will be described later, another soundness condition can be also derived by using the elastic curve equation.

### Advantageous Effect

The information processing apparatus 2000 according to the present example embodiment recognizes the degree of soundness of the structure 10 by using the soundness condition derived from the elastic curve equation determined in structural mechanics and material mechanics. More specifically, information relating to the soundness degree of the structure 10 is generated by applying a moving weight to the structure 10 and determining whether the temporal change in the deflection amount and the temporal change in the application position of a load satisfy the soundness condition. As described above, the information processing apparatus 2000 according to the present example embodiment provides a new technique for recognizing a soundness degree of a structure. Further, since a property of a structure, called the elastic curve equation, determined in structural mechanics and material mechanics is used, the degree of soundness of the structure 10 can be recognized accurately.

Note that, the above description with reference to FIG. 1 is merely illustrative for ease of understanding the information processing apparatus 2000, and does not limit a function of the information processing apparatus 2000. Hereinafter, the information processing apparatus 2000 according to the present example embodiment will be described in further detail.

### <Example of Function Configuration>

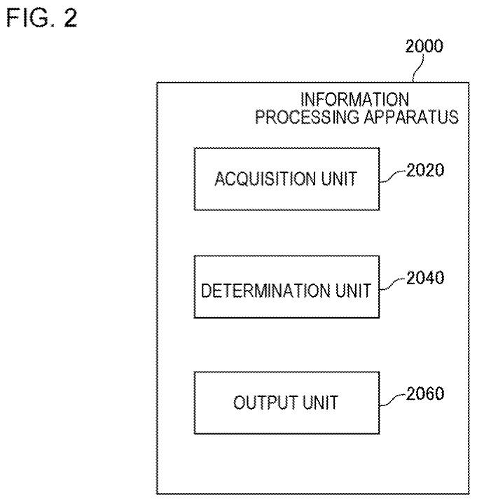

FIG. 2 is a diagram illustrating a function configuration of the information processing apparatus 2000 according to the example embodiment 1. The information processing apparatus 2000 includes an acquisition unit 2020, a determination unit 2040, and an output unit 2060. The acquisition unit 2020 acquires observation information. The determination unit 2040 determines, by using the observation information, whether a temporal change in deflection amount and a temporal change in an application position satisfy a soundness condition. The output unit 2060 outputs output information, based on a determination result made by the determination unit.

### <Hardware Configuration of Information Processing Apparatus 2000>

Each of function configuration units of the information processing apparatus 2000 may be achieved by hardware (example: a hard-wired electronic circuit, or the like) achieving each of the function configuration units, or may be achieved by a combination of hardware and software (example: a combination of an electronic circuit and a program controlling the electronic circuit, or the like). Hereinafter, a case will be further described in which each of the function configuration units of the information processing apparatus 2000 is achieved by the combination of hardware and software.

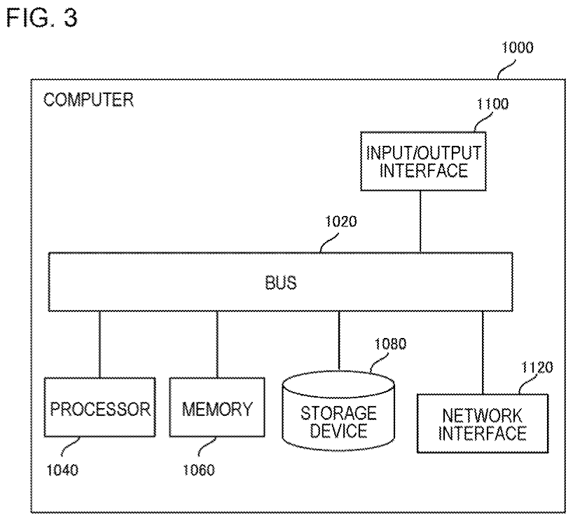

FIG. 3 is a diagram illustrating a computer 1000 for achieving the information processing apparatus 2000. The computer 1000 is any computer. For example, the computer 1000 is a stationary computer such as a personal computer (PC) or a server machine. Other than the above, for example, the computer 1000 is a portable computer such as a smartphone or a tablet terminal. The computer 1000 may be a dedicated computer designed for achieving the information processing apparatus 2000, or may be a general-purpose computer.

The computer 1000 includes a bus 1020, a processor 1040, a memory 1060, a storage device 1080, an input/output interface 1100, and a network interface 1120. The bus 1020 is a data transmission line through which the processor 1040, the memory 1060, the storage device 1080, the input/output interface 1100, and the network interface 1120 transmit and receive data to and from one another. However, a method of connecting the processor 1040 and the like with one another is not limited to bus connection.

The processor 1040 is a processor of various types such as a central processing unit (CPU), a graphics processing unit (GPU), and a field-programmable gate array (FPGA). The memory 1060 is a primary storage apparatus achieved by using a random access memory (RAM) or the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 with an input/output device. For example, an input apparatus such as a keyboard and an output apparatus such as a display apparatus are connected to the input/output interface 1100.

The network interface 1120 is an interface for connecting the computer 1000 to a communication network. The communication network is, for example, a local area network (LAN) or a wide area network (WAN). A method by which the network interface 1120 connects to the communication network may be wireless connection, or may be wired connection.

The storage device 1080 stores a program module for achieving each of the function configuration units of the information processing apparatus 2000. The processor 1040 achieves a function associated with each program module, by reading each of the program modules into the memory 1060 and executing the program module.

### <Flow of Processing>

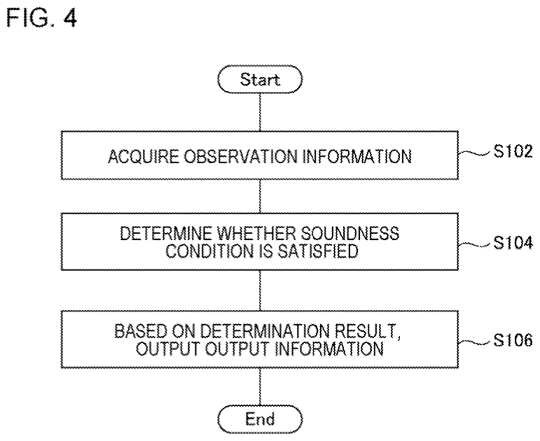

FIG. 4 is a flowchart illustrating a flow of processing executed by the information processing apparatus 2000 according to the example embodiment 1. The acquisition unit 2020 acquires observation information (S102). The determination unit 2040 determines, by using the observation information and a soundness condition, whether a temporal change in deflection amount of the structure 10 and a temporal change in an application position satisfy the soundness condition (S104). The output unit 2060 outputs output information by using a determination result in S204 (S106).

### <Regarding Soundness Condition>

### <<Method of Deriving Soundness Condition in Equation (2)>>

A method of deriving the soundness condition in equation (2) will be described. As described above, the soundness condition in the equation (2) can be acquired based on the elastic curve equation indicated below again.

$$\begin{matrix}[ Mathematical 3 ] & \\ δ = \{ \begin{matrix}\frac{f ( L - {x}_{w} )}{6 EIL} x ( - {x}^{2} - {x}_{w}^{2} + 2 {Lx}_{w} ) & ( 0 \leq x \leq {x}_{w} ) \\ \frac{f ( L - x )}{6 EIL} {x}_{w} ( - {x}_{w}^{2} - {x}^{2} + 2 Lx ) & ( {x}_{w} \leq x \leq L )\end{matrix} & ( 1 )\end{matrix}$$

First, when the equation (1) is differentiated with respect to xw, a following equation (3) can be acquired.

$$\begin{matrix}[ Mathematical 4 ] & \\ \frac{\partial δ}{\partial {x}_{w}} = \{ \begin{matrix}\frac{fx}{6 EIL} \{ 3 {( L - {x}_{w} )}^{2} + {x}^{2} - {L}^{2} \} & ( 0 \leq x \leq {x}_{w} ) \\ \frac{f ( L - x )}{6 EIL} \{ - {( L - x )}^{2} - 3 {x}_{w}^{2} + {L}^{2} \} & ( {x}_{w} \leq x \leq L )\end{matrix} & ( 3 )\end{matrix}$$

Herein, the application position xw changes with time, because the deflection amount is observed while the application position is changed. In view of this, when the deflection amount is differentiated with respect to the time t, a following equation (4) can be acquired.

$$\begin{matrix}[ Mathematical 5 ] & \\ \frac{dδ}{dt} = \frac{\partial δ}{\partial {x}_{w}} \frac{\partial {x}_{w}}{\partial t} & ( 4 )\end{matrix}$$

Then, when the equation (3) is substituted into the equation (4), the above-described equation (2) indicated below again can be acquired.

$$\begin{matrix}[ Mathematical 6 ] & \\ \frac{dδ}{dt} = \{ \begin{matrix}\frac{fx}{6 EIL} \{ 3 {( L - {x}_{w} )}^{2} + {x}^{2} - {L}^{2} \} \frac{\partial {x}_{w}}{\partial t} & ( 0 \leq x \leq {x}_{w} ) \\ \frac{f ( L - x )}{6 EIL} \{ - {( L - x )}^{2} - 3 {x}_{w}^{2} + {L}^{2} \} \frac{\partial {x}_{w}}{\partial t} & ( {x}_{w} \leq x \leq L )\end{matrix} & ( 2 )\end{matrix}$$

### <<Second Soundness Condition>>

Hereinafter, a soundness condition other than the equation (2) will be described. Note that, the soundness condition in the equation (2) will be written as a first soundness condition, in order to distinguish the soundness condition in the equation (2) from the soundness condition described below.

The equation (2) includes an observation position x of deflection. However, the observation position x cannot be acquired in some cases due to a restriction on observation work, and the like. In view of this, a soundness condition that is usable even when the observation position x is unknown, in other words, a soundness condition of which an equation does not explicitly include the observation position x of deflection is useful.

First, when the equation (1) is differentiated with respect to x, a following equation (5) is acquired.

$$\begin{matrix}[ Mathematical 7 ] & \\ \frac{\partial δ}{\partial x} = \{ \begin{matrix}\frac{f ( L - {x}_{w} )}{6 EIL} \{ - {( L - {x}_{w} )}^{2} - 3 {x}^{2} + {L}^{2} \} & ( 0 \leq x \leq {x}_{w} ) \\ \frac{{fx}_{w}}{6 EIL} \{ 3 {( L - x )}^{2} + {x}_{w}^{2} - {L}^{2} \} & ( {x}_{w} \leq x \leq L )\end{matrix} & ( 5 )\end{matrix}$$

Then, when the equation (5) solved for x is substituted into the equation (2), a following equation (6) can be acquired.

$$\begin{matrix}[ Mathematical 8 ] & \\ {( \frac{dδ}{dt} )}^{2} = \{ \begin{matrix}\begin{matrix}- \frac{{Lv}^{2}}{27 {K ( L - {x}_{w} )}^{3}} \{ \frac{\partial δ}{\partial x} - \frac{K}{L} {x}_{w} ( L - {x}_{w} ) ( 2 L - {x}_{w} \} \\ \{ \frac{\partial δ}{\partial x} - \frac{2 K}{L} ( L - {x}_{w} ) ( L - 2 {x}_{w} ) {( 3 L - 2 {x}_{w} \}}^{2}\end{matrix} ( 0 \leq x \leq {x}_{w} ) \\ \begin{matrix}\frac{{Lv}^{2}}{27 {Kx}_{w}^{3}} \{ \frac{\partial δ}{\partial x} + \frac{K}{L} {x}_{w} ( L + {x}_{w} ) ( L - {x}_{w} \} \\ {\{ \frac{\partial δ}{\partial x} - \frac{2 K}{L} {x}_{w} ( L + 2 {x}_{w} ) ( L - 2 {x}_{w} ) \}}^{2}\end{matrix} ( {x}_{w} \leq x \leq L )\end{matrix} \\ where K = \frac{f}{6 EI} , v = \frac{\partial {x}_{w}}{\partial t} \text{?} \\ \text{?} \text{indicates text missing or illegible when filed} & ( 6 )\end{matrix}$$

Note that, in the equation (6), Max is necessary, whereas the observation position x of deflection is unnecessary. ∂δ/∂x can be computed by, for example, observing the deflection amount at two positions different from each other. Specifically, ∂δ/∂x can be computed in a way as follows.

$$\begin{matrix}[ Mathematical 9 ] & \\ \frac{\partial δ}{\partial x} = \frac{{δ}_{2} - {δ}_{1}}{Δ x} & ( 7 )\end{matrix}$$

Herein, δ1 and δ2 are the deflection amount observed at two positions different from each other, and Δx represents a distance between the observation positions. Therefore, whether the soundness condition is satisfied can be determined with the use of the equation (6), as long as the deflection amount is observed at two observation positions and the deflection amount at the two observation positions and a distance between the two observation positions can be acquired from observation information, even when the position at which the deflection amount is observed is unknown.

For example, it is assumed that a captured image acquired by capturing an image of the structure 10 with a camera is used to observe deflection at each of two observation positions included in the captured image. In this case, even with the use of the captured image and a camera parameter, it may be difficult to determine which position on the entire structure 10 the observation position corresponds. On the other hand, it is possible to easily determine, from the captured image, a distance between the two observation positions included in the captured image, by using the captured image and the camera parameter. Therefore, in this case, it can be said that the soundness condition in the equation (6) is usable although the soundness condition in the equation (2) cannot be used.

Note that, when Δx is sufficiently small, ∂δ/∂x represents a deflection angle at the position x. Thus, the equation (6) can be also regarded as a relational equation between the temporal change in the deflection amount and the deflection angle. As described above, with the use of a plurality of material properties of the structure 10, that is, the deflection amount and the deflection angle, the soundness degree of the structure 10 can be recognized more accurately, in comparison with a case of focusing on only one material property.

### <<Third Soundness Condition>>

There is also a case in which the observation position x of deflection changes with time. For example, it is assumed that a captured image acquired by capturing an image of the structure 10 with a camera is used to observe deflection. In this case, the observation position is a position on the image-captured structure 10. Thus, when images are captured repeatedly while an image capture range of the camera is changed with time (for example, while an image capture range is moved from left to right of the structure 10) and the deflection amount is computed from each of the plurality of acquired captured images, the observation position changes with time.

In this case, a term relating to a temporal change in the observation position can be included in a soundness condition. First, when the deflection amount is differentiated with respect to the time t, a following equation (8) can be acquired.

$$\begin{matrix}[ Mathematical 10 ] & \\ \frac{dδ}{dt} = \frac{\partial δ}{\partial x} \frac{\partial x}{\partial t} + \frac{\partial δ}{\partial {x}_{w}} \frac{\partial {x}_{w}}{\partial t} & ( 8 )\end{matrix}$$

Then, when the equation (3) and the equation (5) are substituted into the equation (8), a following equation (9) can be acquired.

$$\begin{matrix}[ Mathematical 11 ] & \\ \frac{dδ}{dt} = \{ \begin{matrix}\begin{matrix}\frac{f ( L - {x}_{w} )}{6 EIL} \{ - {( L - {x}_{w} )}^{2} - 3 {x}^{2} + {L}^{2} \} \frac{\partial x}{\partial t} + \\ \frac{fx}{6 EIL} \{ 3 {( L - {x}_{w} )}^{2} + {x}^{2} - {L}^{2} \} \frac{\partial {x}_{w}}{\partial t}\end{matrix} & ( 0 \leq x \leq {x}_{w} ) \\ \begin{matrix}\frac{{fx}_{w}}{6 EIL} \{ 3 {( L - x )}^{2} + {{x}_{w}}^{2} - {L}^{2} \} \frac{\partial x}{\partial t} + \\ \frac{f ( L - x )}{6 EIL} \{ - {( L - x )}^{2} - 3 {x}_{w}^{2} + {L}^{2} ) \frac{\partial {x}_{w}}{\partial t}\end{matrix} & ( {x}_{w} \leq x \leq L )\end{matrix} & ( 9 )\end{matrix}$$

The equation (9) can be also used as a soundness condition. Herein, the soundness condition in the equation (9) can be regarded as a relation satisfied by the temporal change in the deflection amount, the temporal change in the observation position, and the temporal change in the application position.

### <<Fourth Soundness Condition>>

A case is also conceivable in which the observation position x of the deflection amount changes with time and the observation position of the deflection amount cannot be acquired. A soundness condition usable in this case can be acquired by transforming the above-described soundness condition in the equation (9) into a form in which x does not explicitly appear. Specifically, the soundness condition can be acquired when the equation (5) solved for x is substituted into the equation (9). The soundness condition will not be written specifically.

### <Acquisition of Observation Information: S102>

The acquisition unit 2020 acquires observation information (S102). The observation information is information relating to observation of deflection performed on the structure 10 to which a moving load is applied. The observation information includes at least information relating to application of a load and information relating to deflection.

### <<Information Relating to Load>>

Regarding a load, for example, the observation information indicates a plurality of pairs of “the application position and the time at which a load is applied to the application position”. As described above, the temporal change ∂xw/∂t in the application position can be computed from the information. However, the observation information may directly indicate the temporal change in the application position.

Note that, when there are three or more above-described pairs, the temporal change in the application position can be computed regarding a plurality of times. However, the observation information may indicate a plurality of “the time and the temporal change in the application position at the time”.

The application position can be computed by, for example, using a position sensor (for example, a global positioning system (GPS) sensor) or the like mounted on an apparatus that applies a load to the structure 10. Further, the time can be acquired from a clock or the like mounted on the apparatus that applies a load.

As the apparatus that applies a load to the structure 10, various things can be used. For example, a vehicle can be used, such as an automobile described above.

### <<Information Relating to Deflection>>

Regarding deflection, for example, the observation information indicates a plurality of pairs of “the deflection amount and the time at which the deflection amount is observed”. As described above, the temporal change dδ/dt in the deflection amount can be computed from the information. However, the observation information may directly indicate the temporal change in the deflection amount.

Note that, when there are three or more above-described pairs, the temporal change in the deflection amount can be computed regarding a plurality of times. However, the observation information may indicate a plurality of “the time and the temporal change in the deflection amount at the time”.

As a technique for computing the deflection amount of the structure 10, an existing technique can be used. For example, there is a method in which a displacement sensor is mounted at the observation position of the structure 10 and the deflection amount is computed based on a detected value of the sensor. Other than the above, for example, the deflection amount can be computed also by capturing an image of the structure 10 with a camera and analyzing the captured image.

Note that, when the second soundness condition or the fourth soundness condition is used, ∂δ/∂x is necessary. In this case, for example, the observation information indicates a pair of “the deflection amount at two observation positions different from each other and the distance between the observation positions”. From the information and the equation (7), Max can be computed. Further, the observation information may directly indicate Max.

### <<Other Information>>

Other than the above, the observation information indicates the observation position. Note that, when the observation position changes with time, the observation information indicates a plurality of pairs of “the observation position and the time”. The observation position can be computed by, for example, using a position sensor (for example, a global positioning system (GPS) sensor) or the like at the observation position.

Note that, although the observation position may be any position, it is preferred that observation is performed at a center position (L/2) between supports of the structure 10 or at a position close to the center position. This is because the observation is less likely to be affected by a measurement error, since a position far from a member supporting the structure 10 tends to have large deflection.

Further, the observation information may further indicate the span length L of the structure 10. The span length of the structure 10 may be acquired from a design drawing of the structure 10 and the like, or may be acquired by surveying with use of a surveying instrument.

Further, the span length may be computed based on time required for an apparatus, such as the automobile 20, as a means for applying a moving load, to move between the supports of the structure 10, and on a moving speed of the apparatus.

### <<Method of Acquiring Observation Information>>

There are various methods of acquiring the observation information by the acquisition unit 2020. For example, the acquisition unit 2020 acquires the observation information by accessing a storage apparatus in which the observation information is stored. The storage apparatus may be provided inside the information processing apparatus 2000, or may be provided outside the information processing apparatus 2000. Other than the above, for example, the information processing apparatus 2000 may acquire the observation information by receiving the observation information transmitted from another apparatus. The “another apparatus” is, for example, an apparatus having performed observation on the structure 10.

Note that, information relating to a load and information relating to deflection may be transmitted from different apparatuses. For example, the information relating to the load is transmitted from an apparatus (for example, the automobile 20) used for application of the load. On the other hand, the information relating to the deflection is transmitted from an apparatus used for observation and analysis of the deflection (for example, a displacement sensor, or an apparatus having analyzed a captured image).

### <Determination Using Soundness Condition: 104>

The determination unit 2040 determines, by using the observation information, whether a soundness condition is satisfied for the structure 10 (S104). Herein, in each soundness condition, in order to specifically output a value on a right-hand side, the magnitude F of a load, the Young's modulus E of the structure 10, and the second moment of area I of the structure 10 are included. However, it is possible to determine whether the soundness condition is satisfied, even without specifically calculating a value on the right-hand side.

Hereinafter, an operation of the determination unit 2040 will be described for both of a case in which the magnitude F of a load, the Young's modulus E of the structure 10, and the second moment of area I of the structure 10 are all known and a case in which any one or more of the above are unknown.

<<Case in which F, E, and I are all Known>>

In this case, both of a left-hand side and a right-hand side of a soundness condition can be specifically computed. Thus, the determination unit 2040 computes, for each of one or more times, a difference between values on the left-hand side and the right-hand side of the soundness condition by using an observation result, and determines whether magnitude of the difference (an absolute value of the difference, a square of the difference, or the like) is equal to or more than a threshold value. Concerning an observed value at a certain time, when the magnitude of the difference is equal to or more than the threshold value, the determination unit 2040 determines that the soundness condition is not satisfied for the time. On the other hand, concerning an observed value at a certain time, when the magnitude of the difference is less than the threshold value, the determination unit 2040 determines that the soundness condition is satisfied for the time. Further, the magnitude of the difference may be integrated for all times, and a value thus integrated may be compared with the threshold value.

A method of specifically calculating values on the left-hand side and the right-hand side of the soundness condition in this way needs no processing such as linear regression to be described later, and thus, has an advantage of requiring small computational cost for determining whether the soundness condition is satisfied.

<<Case in which any One or More of F, E, and I are Unknown>>

In this case, a value on a right-hand side of a soundness condition cannot be specifically calculated. However, at least when the first soundness condition and the third soundness condition described above are used, it is possible to recognize whether the soundness condition is satisfied, even when a value on the right-hand side is not specifically computed. Hereinafter, a method therefor will be specifically described.

### <<<Regarding First Soundness Condition>>>

When K=f/6EI, the first soundness condition can be expressed in a form of y=K*u. Specifically, the first soundness condition can be expressed as follows.

$$\begin{matrix}[ Mathematical 12 ] & \\ y = Ku & ( 10 ) \\ where & \\ y = \frac{dδ}{dt} & \\ u = \{ \begin{matrix}\frac{x}{L} \{ 3 {( L - {x}_{w} )}^{2} + {x}^{2} - {L}^{2} \} \frac{\partial {x}_{w}}{\partial t} & ( 0 \leq x \leq {x}_{w} ) \\ \frac{L - x}{L} \{ - {( L - x )}^{2} - 3 {x}_{w}^{2} + {L}^{2} \} \frac{\partial {x}_{w}}{\partial t} & ( {x}_{w} \leq x \leq L )\end{matrix} & \\ K = \frac{f}{6 EI} & \end{matrix}$$

Thus, when a value y on the left-hand side and a value u of a part enclosed with K on the right-hand side are computed and (u, y) is plotted on a graph, plots fall on one straight line when the soundness condition is satisfied. In view of this, for example, the determination unit 2040 computes, for each time t, a value y(t) on the left-hand side of the soundness condition and a value u(t) of a part enclosed with K on the right-hand side by using an observation result acquired for each of a plurality of times, and performs linear regression for (u(t), y(t)). For example, the linear regression can be performed by using a least squares method. More specifically, K representing an inclination of the straight line can be computed by solving an optimization problem indicated below.

$$\begin{matrix}[ Mathematical 13 ] & \\ {min}_{K} {Σ}_{t} {\{ y ( t ) - K * u ( t ) \}}^{2} & ( 11 )\end{matrix}$$

Herein, when the structure 10 has a low soundness degree, there is a time at which the soundness condition is not satisfied, and thus, a plot associated with the time largely deviates from a regression line. Thus, when the structure 10 has a low soundness degree, a minimum value of a residual sum of squares acquired as a result of the above-described optimization problem is large in comparison with a case of the structure 10 having a high soundness degree.

In view of the above, for example, the determination unit 2040 compares a minimum value of a residual sum of squares acquired as a result of the linear regression with the threshold value, and, when the minimum value of the residual sum of squares is equal to or more than the threshold value, determines that the soundness condition is not satisfied. On the other hand, when the minimum value of the residual sum of squares is less than the threshold value, the determination unit 2040 determines that the soundness condition is satisfied.

Note that, the above-described optimization problem may be a problem of minimizing a root mean squared error (RMSE) and the like instead of the residual sum of squares. In this case, the determination unit 2040 determines whether the soundness condition is satisfied, by comparing a minimum value of the RMSE with the threshold value.

Herein, a threshold value may be set for an absolute value of a residual or a squared residual, and whether these values are equal to or more than the threshold value at each time may be determined. When the absolute value of the residual or the squared residual at a certain time is equal to or more than the threshold value, it can be seen that a plot for the time largely deviates from the regression line. Thus, by determining the application position xw at the time, the position can be determined as a defective position (a position where cracking and the like is occurring) of the structure 10.

Further, instead of determining whether the soundness condition is satisfied by comparison between the residual sum of squares or the RMSE and a threshold value, the determination unit 2040 may determine whether the soundness condition is satisfied by comparing the absolute value of the residual or the squared residual at each time with the threshold value. For example, when there are a predetermined number or more of times at which the absolute value of the residual or the squared residual is equal to or more than the threshold value, the determination unit 2040 determines that the soundness condition is not satisfied. On the other hand, when there are less than a predetermined number of times at which the absolute value of the residual or the squared residual is equal to or more than the threshold value, the determination unit 2040 determines that the soundness condition is satisfied. The predetermined number may be 1, or may be any number greater than 1.

The method of using the linear regression described herein can determine whether the soundness condition is satisfied, even when the magnitude f of a load, the Young's modulus E of the structure 10, and the second moment of area I of the structure 10 are unknown. In particular, it can be considered that recognizing the Young's modulus and the second moment of area is often difficult. Thus, by using the method capable of determining whether the soundness condition is satisfied without use, of such information difficult to recognize, the soundness degree can be determined in an increased number of situations. In other words, the information processing apparatus 2000 can be used in an increased number of situations.

### <<<Regarding Third Soundness Condition>>>

In the third soundness condition, the observation position x also changes as well as the application position xw. Thus, multiple regression is performed rather than the linear regression. Specifically, the multiple regression is performed by representing the soundness condition in the equation (9) as follows.

$$\begin{matrix}[ [ Mathematical 14 ] & \\ y = {Ku}_{1} + {Ku}_{2} & ( 12 ) \\ where & \\ y = \frac{dδ}{dt} & \\ {u}_{1} = \{ \begin{matrix}\frac{( L - {x}_{w} )}{L} \{ - {( L - {x}_{w} )}^{2} - 3 {x}^{2} + {L}^{2} \} \frac{\partial x}{\partial t} & ( 0 \leq x \leq {x}_{w} ) \\ \frac{{x}_{w}}{L} \{ 3 {( L - x )}^{2} + {{x}_{w}}^{2} - {L}^{2} \} \frac{\partial x}{\partial t} & ( {x}_{w} \leq x \leq L )\end{matrix} & \\ {u}_{2} = \{ \begin{matrix}\frac{x}{L} \{ 3 {( L - {x}_{w} )}^{2} + {x}^{2} - {L}^{2} \} \frac{\partial {x}_{w}}{\partial t} & ( 0 \leq x \leq {x}_{w} ) \\ \frac{( L - x )}{L} \{ - {( L - x )}^{2} - 3 {x}_{w}^{2} + {L}^{2} \} \frac{\partial {x}_{w}}{\partial t} & ( {x}_{w} \leq x \leq L )\end{matrix} & \\ K = \frac{f}{6 EI} & \end{matrix}$$

Then, for example, the determination unit 2040 compares a minimum value of a residual sum of squares acquired by solving a following optimization problem with a threshold value.

$$\begin{matrix}[ Mathematical 15 ] & \\ {min}_{K} {\sum }_{t} {[ y ( t ) - \{ K * {u}_{1} ( t ) + K * {u}_{2} ( t ) \} ]}^{2} & ( 13 )\end{matrix}$$

Note that, comparison between the minimum value of the residual sum of squares and the threshold value is similar to the case of the first soundness condition. Further, an RMSE or the like can be used instead of the residual sum of squares, similarly.

### <Method of Determining Soundness Condition to be Used>

The soundness condition to be used by the determination unit 2040 may be one soundness condition determined in advance, or may be dynamically determined upon an operation of the determination unit 2040. In the latter case, for example, the determination unit 2040 determines the soundness condition to be used, based on a content of the observation information.

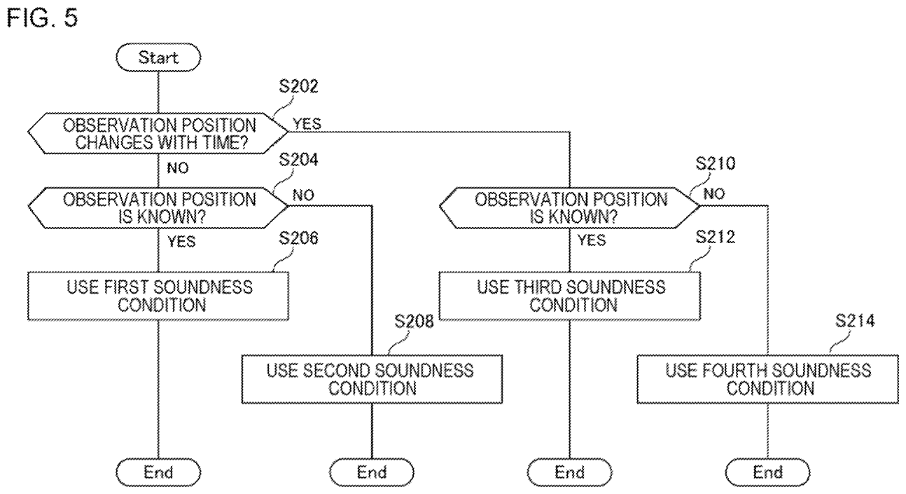

FIG. 5 is a flowchart illustrating a flow of processing of determining the soundness condition to be used. The determination unit 2040 determines whether the observation position changes with time (S202). For example, the determination unit 2040 determines that the observation position changes with time when information representing the temporal change in the observation position is included in the observation information, and determines that the observation position does not change with time when not included.

When it is determined that the observation position does not change (S202: NO), the determination unit 2040 determines whether the observation position is known (S204). For example, the determination unit 2040 determines that the observation position is known when the observation position is included in the observation information, and determines that the observation position is not known when not included. When the observation position is known (S204: YES), the determination unit 2040 determines the first soundness condition as a soundness condition to be used for determination (S206). On the other hand, when the observation position is not known (S204: NO), the determination unit 2040 determines the second soundness condition as a soundness condition to be used for determination (S208).

When it is determined that the observation position changes (S202: YES), the determination unit 2040 determines whether the observation position is known (S210). When the observation position is known (S210: YES), the determination unit 2040 determines the third soundness condition as a soundness condition to be used for determination (S212). On the other hand, when the observation position is not known (S210: NO), the determination unit 2040 determines the fourth soundness condition as a soundness condition to be used for determination (S214).

### <Output of Output Information>

The output unit 2060 outputs, based on a result of determination made by the determination unit 2040, output information relating to the soundness degree of the structure 10 (S106). For example, the output information is information indicating a determination result as to whether the soundness condition is satisfied. Herein, when determination is made as to whether the soundness condition is satisfied for each of observed values at a plurality of times, the output information preferably indicates the determination result as to whether the soundness condition is satisfied, in association with a time and an application position at which a load is applied at the time.

Other than the above, for example, the output information may be an index value used for determination as to whether the soundness condition is satisfied. In a case in which any one or more of F, E, and I are unknown, for example, a minimum value or the like of a residual sum of squares or an RMSE acquired as a result of regression is output as the index value. Further, in a case in which F, E, and I are all known, for example, magnitude of a difference between values on the left-hand side and the right-hand side of the soundness condition is output as the index value.

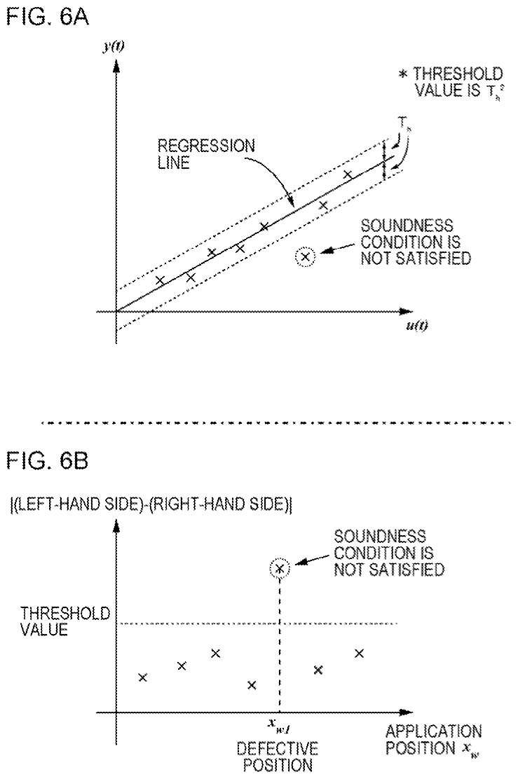

It is preferable that the output information graphically indicates information relating to determination of the soundness condition relating to the soundness degree of the structure 10 by means of a table, a graph, or the like. FIG. 6 is a diagram illustrating information relating to the determination of the soundness condition by means of a graph. An upper section in FIG. 6 represents a result of linear regression by means of a graph. A horizontal axis represents u, and a vertical axis represents y. Further, a value Th of a square root of a threshold value (defined as Th\hat{ }2) compared with a residual sum of squares is represented by a dotted line. Then, a plot for the residual sum of squares being equal to or more than the threshold value is highlighted. Accordingly, it is possible to visually and easily recognize that the structure 10 has a low soundness degree. Note that, information indicating a defective position may be output around a plot for an unsatisfied soundness condition.

In an example of a lower section in FIG. 6, an absolute value of a difference between values on the left-hand side and the right-hand side of the soundness condition is represented by means of a graph. A horizontal axis represents the application position xw at which a load is applied, and a vertical axis represents the absolute value of the difference between values on a side and the right-hand side. Further, a threshold value is represented by a dotted line.

Furthermore, a plot for the absolute value of the difference being equal to or more than the threshold value is highlighted. Accordingly, it is possible to visually and easily recognize a fact that the structure 10 has a low soundness degree, and a defective position of the structure 10.

Furthermore, a determination result acquired in the past for the same structure 10 or a result of determination performed on another structure 10 may be made available for comparison. In this case, the horizontal axis and the vertical axis of the graph described above are standardized.

While the example embodiments of the present invention have been described with reference to the drawings, the above-described example embodiments are illustrative of the present invention, and various configurations other than the above may be employed.

The whole or part of the example embodiments disclosed above can be described as, but not limited to, the following supplementary notes.

1. An information processing apparatus including:

an acquisition unit that acquires observation information relating to a result of observing deflection of a structure caused by applying a load to the structure while changing an application position;

a determination unit that determines, by using the observation information, whether a temporal change in amount of the deflection and a temporal change in the application position satisfy a predetermined condition; and

an output unit that outputs, based on a determination result made by the determination unit, information relating to a degree of soundness of the structure.

2. The information processing apparatus according to supplementary note 1, wherein

the predetermined condition can be derived from an elastic curve equation.

3. The information processing apparatus according to supplementary note 2, wherein

the predetermined condition represents a relation satisfied by a temporal change in amount of the deflection and a temporal change in the application position when the structure is in a sound state, and

the output unit outputs information indicating that the structure is not in a sound state when determination is made that the predetermined condition is not satisfied.

4. The information processing apparatus according to any one of supplementary notes 1 to 3, wherein

the predetermined condition is a condition relating to a temporal change in amount of the deflection, a temporal change in the application position, and a temporal change in an observation position of the deflection.

5. The information processing apparatus according to any one of supplementary notes 1 to 3, wherein

the predetermined condition is a relational equation representing a temporal change in amount of the deflection and a temporal change in the application position in a form of a linear relation, and

the determination unit performs linear regression on the relational equation by using the observation information, and determines, based on a result of the linear regression, whether the predetermined condition is satisfied.

6. The information processing apparatus according to any one of supplementary notes 1 to 4, wherein

the predetermined condition is a relational equation representing a temporal change in amount of the deflection in a form of a linear sum of a temporal change in the application position and a temporal change in an observation position of the deflection, and

the determination unit performs multiple regression on the relational equation by using the observation information, and determines, based on a result of the multiple regression, whether the predetermined condition is satisfied.

7. A control method executed by a computer, including:

an acquisition step of acquiring observation information relating to a result of observing deflection of a structure caused by applying a load to the structure while changing an application position;

a determination step of determining, by using the observation information, whether a temporal change in amount of the deflection and a temporal change in the application position satisfy a predetermined condition; and

an output step of outputting, based on a determination result made in the determination step, information relating to a degree of soundness of the structure.

8. The control method according to supplementary note 7, wherein

the predetermined condition can be derived from an elastic curve equation.

9. The control method according to supplementary note 8, in which

the predetermined condition represents a relation satisfied by a temporal change in amount of the deflection and a temporal change in the application position when the structure is in a sound state; and

in the output step, information indicating that the structure is not in a sound state is output when determination is made that the predetermined condition is not satisfied.

10. The control method according to any one of supplementary notes 7 to 9, wherein

the predetermined condition is a condition relating to a temporal change in amount of the deflection, a temporal change in the application position, and a temporal change in an observation position of the deflection.

11. The control method according to any one of supplementary notes 7 to 9, in which

the predetermined condition is a relational equation representing a temporal change in amount of the deflection and a temporal change in the application position in a form of a linear relation; and

in the determination step, linear regression is performed on the relational equation by using the observation information and, it is determined, based on a result of the linear regression, whether the predetermined condition is satisfied.

12. The control method according to any one of supplementary notes 7 to 10, in which

the predetermined condition is a relational equation representing a temporal change in amount of the deflection in a form of a linear sum of a temporal change in the application position and a temporal change in an observation position of the deflection; and

in the determination step, multiple regression is performed on the relational equation by using the observation information. and determining, based on a result of the multiple regression, whether the predetermined condition is satisfied.

13. A program that causes a computer to execute each of the steps of the control method according to any one of supplementary notes 7 to 12.

What is claimed is:

1. An information processing apparatus comprising:
an acquisition unit that acquires observation information relating to a result of observing deflection of a structure caused by applying a load to the structure while changing an application position;
a determination unit that determines, by using the observation information, whether a temporal change in amount of the deflection and a temporal change in the application position satisfy a predetermined condition; and
an output unit that outputs, based on a determination result made by the determination unit, information relating to a degree of soundness of the structure.

2. The information processing apparatus according to claim 1, wherein
the predetermined condition can be derived from an elastic curve equation.

3. The information processing apparatus according to claim 2, wherein
the predetermined condition represents a relation satisfied by a temporal change in amount of the deflection and a temporal change in the application position when the structure is in a sound state, and
the output unit outputs information indicating that the structure is not in a sound state when determination is made that the predetermined condition is not satisfied.

4. The information processing apparatus according to claim 1, wherein
the predetermined condition is a condition relating to a temporal change in amount of the deflection, a temporal change in the application position, and a temporal change in an observation position of the deflection.

5. The information processing apparatus according to claim 1, wherein
the predetermined condition is a relational equation representing a temporal change in amount of the deflection and a temporal change in the application position in a form of a linear relation, and
the determination unit performs linear regression on the relational equation by using the observation information, and determines, based on a result of the linear regression, whether the predetermined condition is satisfied.

6. The information processing apparatus according to claim 1, wherein
the predetermined condition is a relational equation representing a temporal change in amount of the deflection in a form of a linear sum of a temporal change in the application position and a temporal change in an observation position of the deflection, and
the determination unit performs multiple regression on the relational equation by using the observation information, and determines, based on a result of the multiple regression, whether the predetermined condition is satisfied.

7. A control method executed by a computer, comprising:
an acquisition step of acquiring observation information relating to a result of observing deflection of a structure caused by applying a load to the structure while changing an application position;
a determination step of determining, by using the observation information, whether a temporal change in amount of the deflection and a temporal change in the application position satisfy a predetermined condition; and
an output step of outputting, based on a determination result made in the determination step, information relating to a degree of soundness of the structure.

8. The control method according to claim 7, wherein
the predetermined condition can be derived from an elastic curve equation.

9. The control method according to claim 8, wherein
the predetermined condition represents a relation satisfied by a temporal change in amount of the deflection and a temporal change in the application position when the structure is in a sound state; and
in the output step, information indicating that the structure is not in a sound state is output when determination is made that the predetermined condition is not satisfied.

10. The control method according to claim 7, wherein
the predetermined condition is a condition relating to a temporal change in amount of the deflection, a temporal change in the application position, and a temporal change in an observation position of the deflection.

11. The control method according to claim 7, wherein
the predetermined condition is a relational equation representing a temporal change in amount of the deflection and a temporal change in the application position in a form of a linear relation; and
in the determination step, linear regression is performed on the relational equation by using the observation information and, it is determined, based on a result of the linear regression, whether the predetermined condition is satisfied.

12. The control method according to claim 7, wherein
the predetermined condition is a relational equation representing a temporal change in amount of the deflection in a form of a linear sum of a temporal change in the application position and a temporal change in an observation position of the deflection; and
in the determination step, multiple regression is performed on the relational equation by using the observation information, and determining, based on a result of the multiple regression, whether the predetermined condition is satisfied.

13. A non-transitory computer readable medium storing a program that causes a computer to execute each of steps of a control method, the method comprising
an acquisition step of acquiring observation information relating to a result of observing deflection of a structure caused by applying a load to the structure while changing an application position;
a determination step of determining, by using the observation information, whether a temporal change in amount of the deflection and a temporal change in the application position satisfy a predetermined condition; and
an output step of outputting, based on a determination result made in the determination step, information relating to a degree of soundness of the structure.
